(19) United States
(12) Patent Application Publication
(10) Pub. No.: US 2026/0304348 A1
(43) Pub. Date: Oct. 1, 2026

(54) CACHE MANAGEMENT FOR UE POSITIONING

(71) Applicant: QUALCOMM Incorporated, San Diego, CA (US)

(72) Inventors: Mukesh KUMAR, Hyderabad (IN); Pulkit RAJGADIYA, Hyderabad (IN); Arash MIRBAGHERI, San Diego, CA (US)

(21) Appl. No.: 19/090,265

(22) Filed: Mar. 25, 2025

(51) Int. Cl. H04W 64/00; G01S 5/02

(52) U.S. Cl. CPC H04W 64/00; G01S 5/0205

(57) ABSTRACT

Apparatus, methods, and computer program products for UE positioning are provided. An example method may include transmitting, to a location server, a request for a set of network node positioning information associated with a set of network nodes. The example method may further include receiving, from the location server, the set of network node positioning information. The example method may further include storing, in at least one memory at the UE, the set of network node positioning information based on a network node positioning information cache management algorithm. The example method may further include estimating a location of the UE based on the set of network node positioning information.

### TECHNICAL FIELD

The present disclosure relates generally to communication systems, and more particularly, to wireless communication systems with positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) transmit, to a location server, a request for a set of network node positioning information associated with a set of network nodes. Based at least in part on information stored in the at least one memory, the at least one processor, individually or in any combination, is configured to receive, from the location server, the set of network node positioning information. Based at least in part on information stored in the at least one memory, the at least one processor, individually or in any combination, is configured to store, in the at least one memory, the set of network node positioning information based on a network node positioning information cache management algorithm. Based at least in part on information stored in the at least one memory, the at least one processor, individually or in any combination, is configured to estimate a location of the UE based on the set of network node positioning information.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a tracking reference signal (TRS).

FIG. 6 is a diagram illustrating an example call flow for enhanced cell identifier (ID) (ECID) and position request.

FIG. 7A is a diagram illustrating an example of a UE in communication with a number of positioning cells.

FIG. 7B is a diagram illustrating an example of a usage of timing advance (TA) in positioning.

FIG. 7C is a diagram illustrating an example of a database, a UE, and a location server.

FIG. 8 is a diagram illustrating an example of a movement of a UE and update of network node positioning information.

FIG. 9 is a diagram illustrating example communications between a location server and a UE.

FIG. 10 is a flowchart of a method of wireless communication.

FIG. 11 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts.

However, these concepts may be practiced without these specific details. In some instances, well known structures and components are shown in block diagram form in order to avoid obscuring such concepts.

Aspects provided herein provide mechanism of managing storage of network node positioning information (base station almanac (BSA) information) that the user equipment (UE) may use for positioning. Some aspects may be related to techniques/protocols for optimization of BSA information management, (e.g., requesting, downloading, storing of BSA) to improve power and memory. For maintenance of network node positioning information with a finite amount of storage space available, first-in-first-out, buffer partitioning, usage counter based increasing decreasing associated with entries, distance-based (based on distance of a current serving cell or the UE and a cell associated with the entry), or a combination of any of these may be used.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein.

In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

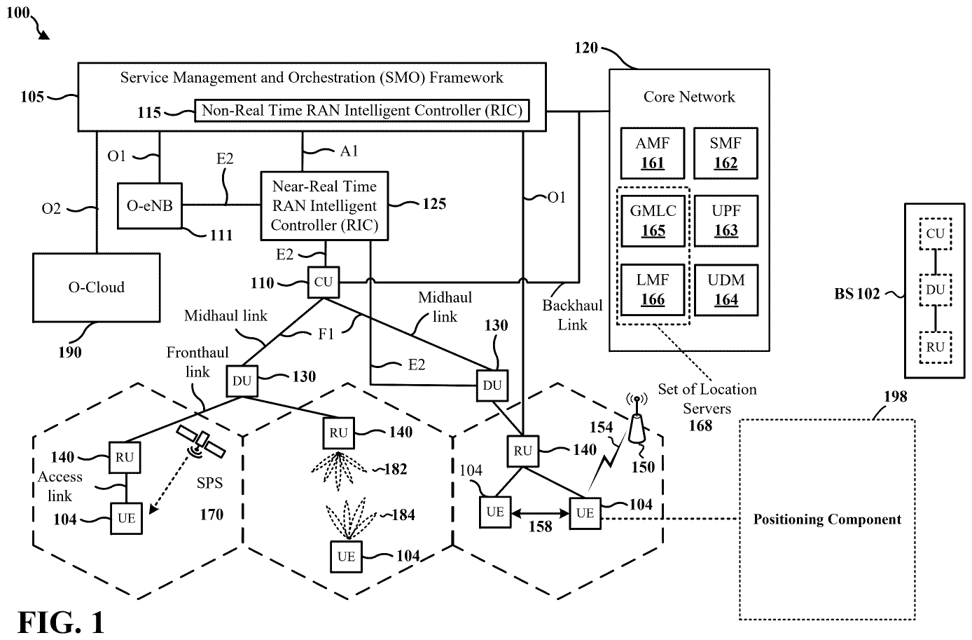

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a positioning component 198. In some aspects, the positioning component 198 may be configured to transmit, to a location server, a request for a set of network node positioning information associated with a set of network nodes. In some aspects, the positioning component 198 may be further configured to receive, from the location server, the set of network node positioning information. In some aspects, the positioning component 198 may be further configured to store, in the at least one memory, the set of network node positioning information based on a network node positioning information cache management algorithm. In some aspects, the positioning component 198 may be further configured to estimate a location of the UE based on the set of network node positioning information.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

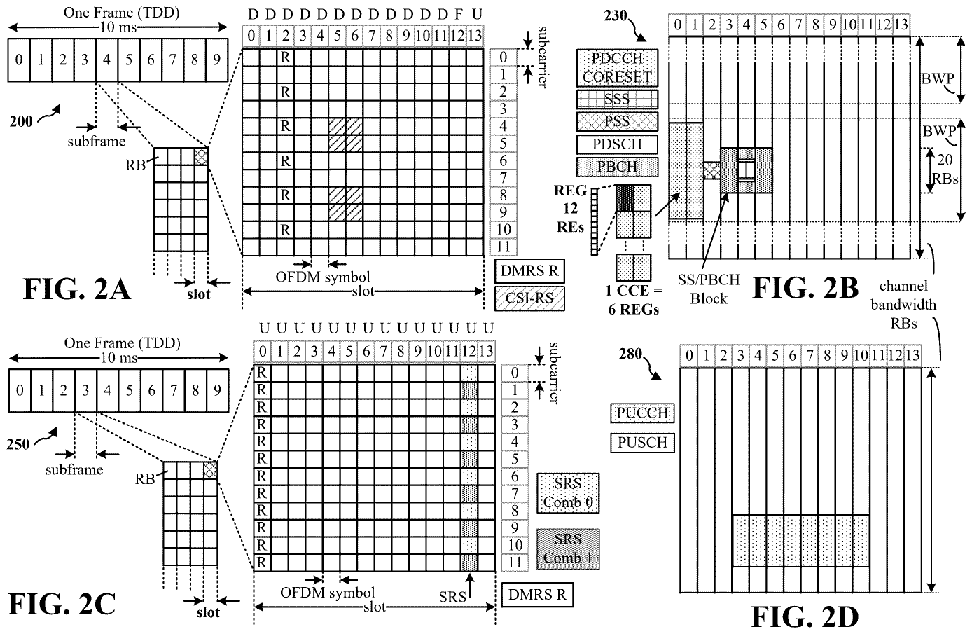

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

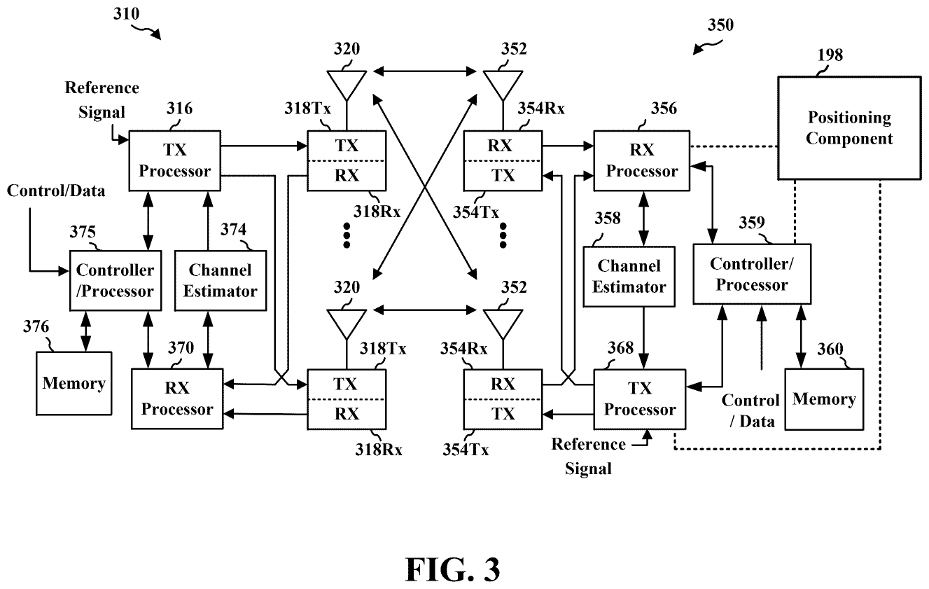

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with positioning component 198 of FIG. 1.

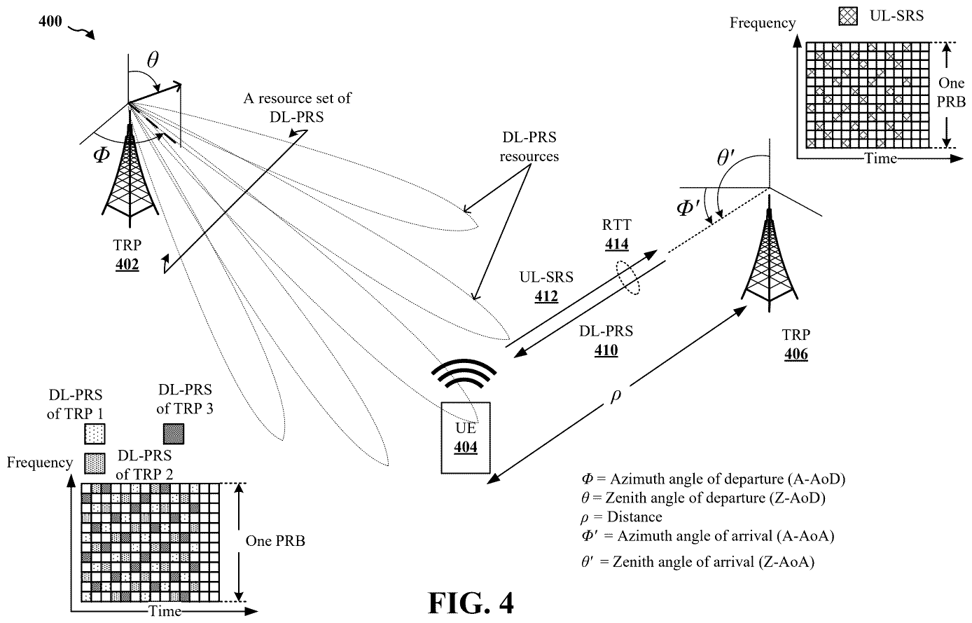

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Aspects provided herein may improve performance of positioning estimation using over the top (OTT) (such as cell-specific reference signal (CRS), TRS, and long training sequence (LTS)) signals by usage of mapping framework which provides the UE/location server with anchor position coordinates. The identifiers of anchors (e.g., cell identifiers (IDs) of TRPs or service set identifier (SSID) of AP) may be scrambled from time to time (e.g., once a day or based on a different periodicity), which prevents computing position without knowledge of which anchor position corresponds to which measurement. When using OTT signals (such as TRS, or the like), the UE or the location server may combine its ToA/TDoA measurements with its knowledge of anchor positions to generate a position estimate. The UE/location server may have access to: (1) a list of ToA/TDoA estimates that may be derived by the UE based on its measurements used by the UE for UE based position estimation or reported to the location server for server based position estimation, and (2) a list of probable anchor positions that may be provided by the location server to the UE (for UE based positioning) and contains the positions of anchors in the surrounding region of the UE. The UE and the location server may combine the information in the two lists using reverse positioning to generate a mapping from the ToA/TDoA measurements to the respective anchor positions. As used herein, the term “network node positioning information” may refer to the anchor positions and related information associated with the different network nodes that may be used as anchors. The network node positioning information may include a number of different entries, where each entry corresponds to one cell. The term “network node positioning information” may also be referred to as “base station almanac (BSA) information/entry.” The network node positioning information may include cell ID or enhanced cell ID (ECID), tracking area code (TAC), mobile network code (MNC), mobile country code (MCC), other forms of cell identity, latitude, longitude, or altitude, sector orientation, operational parameters (e.g., frequency band, channel number (such as E-UTRA absolute radio frequency channel number (EARFCN), transmission power, antenna gain and height), network configuration information (e.g., physical cell identity (PCI) or information about neighboring cells), timing advance, reference signal timing, or deployment type/operator information of the different network nodes that may be used as anchors in positioning.

TRS may be configured at each cell with their own time domain resource, frequency domain resource, and scrambling ID. A UE may be aware of the TRS configuration of its serving cell. TRS may not be fully staggered (e.g., periodic but not uniformly distributed) in frequency (e.g., comb-4, transmitted on every fourth subcarrier), so four peaks may be expected to be observed at the channel estimation response (CER). TRS may be quasi-co-located (QCL'ed) with SSB from a neighboring cell, which could also be measured for the purpose of facilitating time-domain aliasing. QCL relationships may be specified in terms of QCL types. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam).

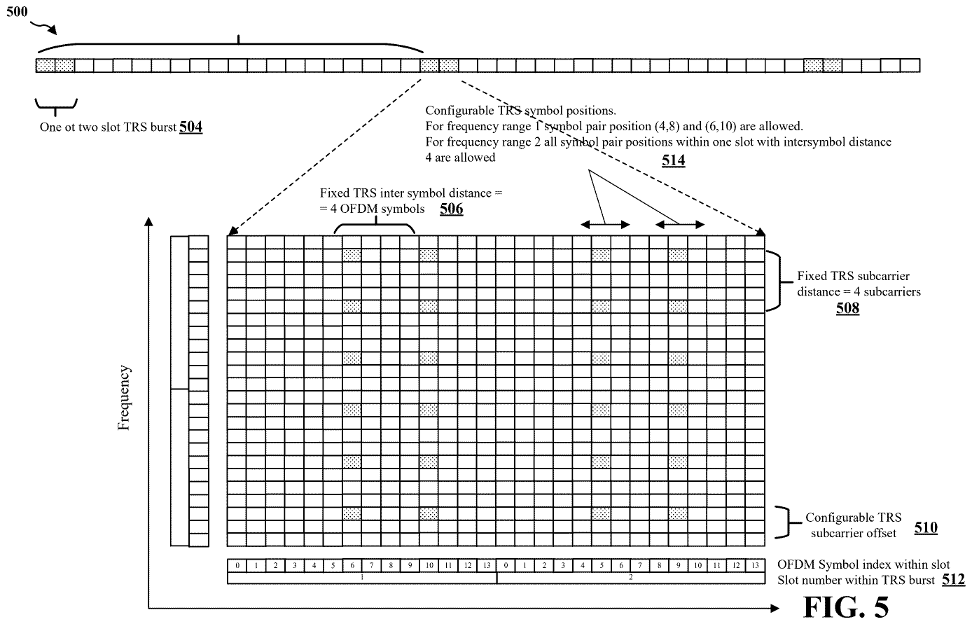

FIG. 5 is a diagram 500 illustrating an example of a tracking reference signal (TRS). As illustrated in FIG. 5, at 502, the TRS burst periodicity may be 10 milliseconds (ms), 20 ms, 40 ms, or 80 ms. At 504, there may be one or two slot(s) of TRS per burst. As illustrated at 506, the TRS inter-symbol distance may be fixed (e.g., four OFDM symbols). As illustrated at 508, the TRS subcarrier distance may be fixed (e.g., four subcarriers). As illustrated at 510, the TRS subcarrier offset may be configurable. As illustrated at 512, the OFDM symbol index within slot and the slot number within TRS burst may be provided. As illustrated at 514, the TRS symbol positions may be configurable where for frequency range 1, symbol pair position (4,8) and (6,10) may be allowed and for frequency range 2, all symbol pair positions within one slot with inter-symbol distance of 4 may be allowed.

A UE may report TRS parameters of its serving cell including time, frequency, scrambling, QCL, and PCI information to a location server. The UE may also report, to the location server, neighboring cells PCIs derived through radio resource management (RRM) procedure. The location server may provide a response with TRS information of neighboring cells (which may have been gathered by other UE's reporting). The UE may then report UE location or raw measurement/TRS that were successfully detected by the UE to the location server.

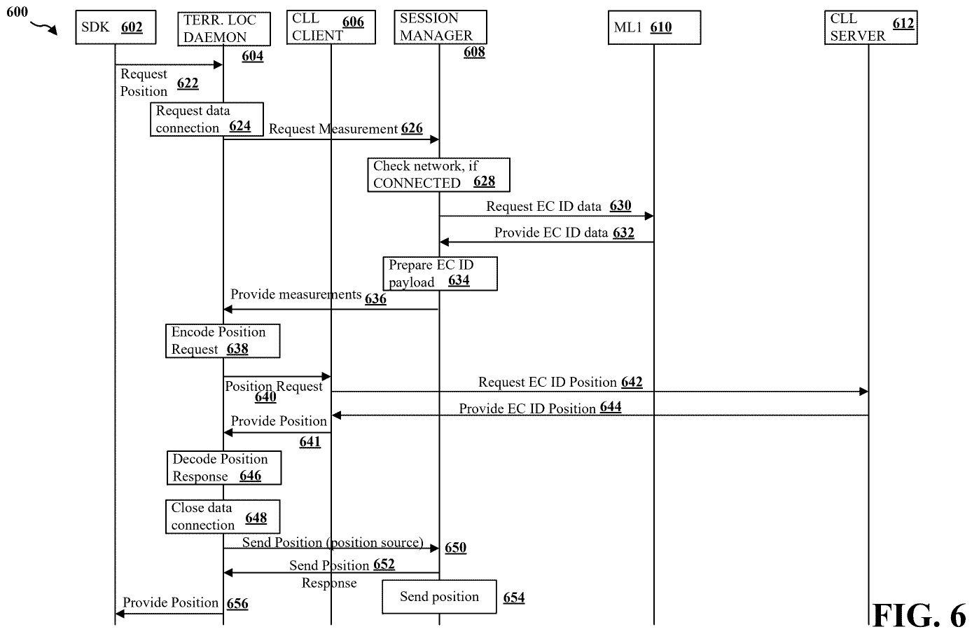

FIG. 6 is a diagram 600 illustrating an example call flow for enhanced cell identifier (ID) (ECID) and position request. As illustrated in FIG. 6, a software development kit (SDK) 602, a territorial location daemon 604, a command-line interface (CLI) client 606, a session manager 608, a layer 1 module (ML1 610), and a CLI server 612 may be present. The SDK 602 may transmit a position request 622 to the territorial location daemon 604, which may request data connection at 624 and transmit a measurement request 626 to the session manager 608. The session manager 608 may check if network is connected at the UE at 628. If it's connected, the session manager 608 may transmit ECID data request 630 to the ML1 610 and receive ECID data 632 from the ML1 610. The session manager 608 may then prepare a ECID payload at 634 and provide measurements 636 to the territorial location daemon 604, which may encode a position request at 638. The territorial location daemon 604 may transmit the encoded position request 640 to the CLI client 606. The CLI client 606 may request ECID position at 642 from the CLI server 612 and may accordingly receive the ECID position at 644, which may be used to determine and provide position (at 641) to territorial location daemon 604. The territorial location daemon 604 may decode the position provided by the CLI client 606 at 646 and close data connection at 648. The territorial location daemon 604 may send position information to the session manager 608 at 650 and receive a response 652. The session manager 608 may send the position to other entities at 654. The position may also be provided to the SDK 602 at 656.

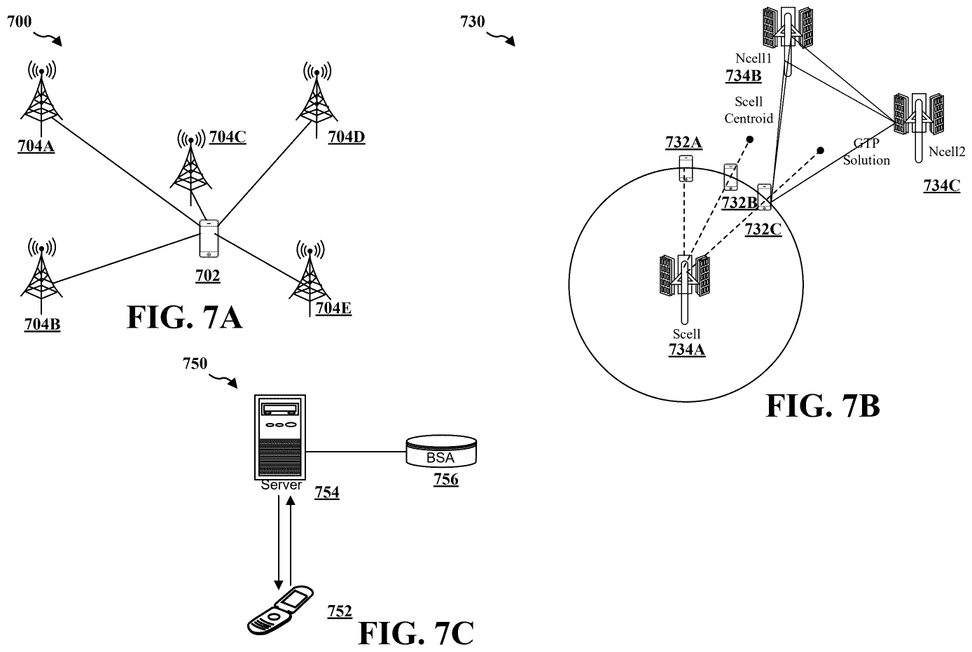

FIG. 7A is a diagram 700 illustrating an example of a UE in communication with a number of positioning cells. To identify positioning cells, a UE may scan a result that includes various measurements, such as air interface technology (AIT), channel, physical cell ID (PCID), reference signal related measurements (such as reference signal received power (RSRP) or the like), or other measurements of for one or more cells. A global cell ID may be available for anchor cells and SCell(s) and the UE may scan (e.g., or acquire based on neighbor cell measurement report (NMR)), by way of example, up to a particular quantity (e.g., one or a different quantity) per frequency range. For example, the UE 702 in FIG. 7A may be able to scan a first cell 704A, a second cell 704B, a third cell 704C, a fourth cell 704D, and a fifth cell 704E. The UE may look up anchor cells in a database with full identifiers. For the remaining cells, the UE may draw a search box around each anchor cell and identify cells in database within the box matching the AIT, channel, PCID, or other information may be found. An anchor cell with the highest count of matched cells may be selected. Assuming N cells with sector centers x₁, . . . . x_{N} and signal power p₁, . . . . P_{N} (in dB), a position estimate may be generated based on:

$$x = \frac{1}{N} {\sum }_{i = 1}^{N} f ( {p}_{i} ) {x}_{i}$$

where power scaling f(pᵢ)=e²*^{0.02}*^{p}^{ᵢ} (e.g., power scaling becomes sharper at lower signal power). There may be a fallback to serving sector centroid if: (1) no other cell is being reported, (2) neighbor cell(s) not found in database, or (3) the calculated position fails consistency check(s).

FIG. 7B is a diagram 730 illustrating an example of a usage of timing advance (TA) in positioning. A TA circle centered on antenna location of SCell 734A with radius calculated from the measured TA may be drawn to estimate a UE's position. Based on the TA relative to the SCell 734A, the UE may be expected to be on the circle, which may be position 732A, position 732B, position 732C, or another position. A first method may be based on planting the UE along the azimuth sourced from carrier BSA and ignore neighbor cell measurements, all RSRP measurements, and crowdsourced database. A second method may use azimuth based on crowdsourced data for SCell and SCell centroid from database may facilitate determination of azimuth. A third method may include using neighbor cell measurements of neighbor cell 734B and neighbor cell 734C; and using the TA as a primary source. The third method may not rely on azimuth or antenna opening from database.

Aspects provided herein provide a mechanism of managing storage of network node positioning information (base station almanac (BSA) information) that the user equipment (UE) may use for positioning. Some aspects may be related to techniques/protocols for optimization of BSA information management, (e.g., requesting, downloading, storing of BSA) to improve power and memory. For maintenance of network node positioning information with a finite amount of storage space available, first-in-first-out (FIFO), buffer partitioning, usage counter based increasing decreasing associated with entries, distance-based (based on distance of a current serving cell or the UE and a cell associated with the entry), or a combination of any of these may be used. Such a maintenance mechanism may be referred to as a “network node positioning information cache management algorithm.”

FIG. 7C is a diagram 750 illustrating an example of a database 756 of BSA, a UE 752, and a location server 754. As illustrated in FIG. 7C, the UE may request network node positioning information stored at the database 756 from the server 754. For every positioning fix that the UE may perform, a UE may use network node positioning information. However, requesting network node positioning information may be signaling overhead costly or power costly for the UE to perform it too frequently. Aspects provided herein may enable the UE to maintain network node positioning information with a finite amount of storage that may be more efficient than requesting network node positioning information every time the UE performs a fix and more memory-efficient than maintaining a complete database of network node positioning information of all possible cells.

In some aspects, a UE may allocate storage capacity (e.g., in at least one memory of the UE) for network node positioning information entries (where each entry corresponds to a cell) of N (e.g., N=200, 300, 500). For any request, M entries may be provided to the UE from the location server, where M may be smaller than N (e.g., M=64). The UE's network node positioning information request may be based on its current serving cell, such as MCC, MNC, TAC, cell identity, or channel number of its current serving cell. In some aspects, the UE may add additional inter-frequencies, AIT, or TAC options. In some aspects, a request of network node positioning information may be triggered upon a serving cell change associated with the UE. In some aspects, the UE may maintain a set (e.g., a list) of cells for which has been network node positioning information requested based on the particular cell being a current serving cell, and refrain from repeating requests upon change to a same serving cell as previously switched to and accordingly requested.

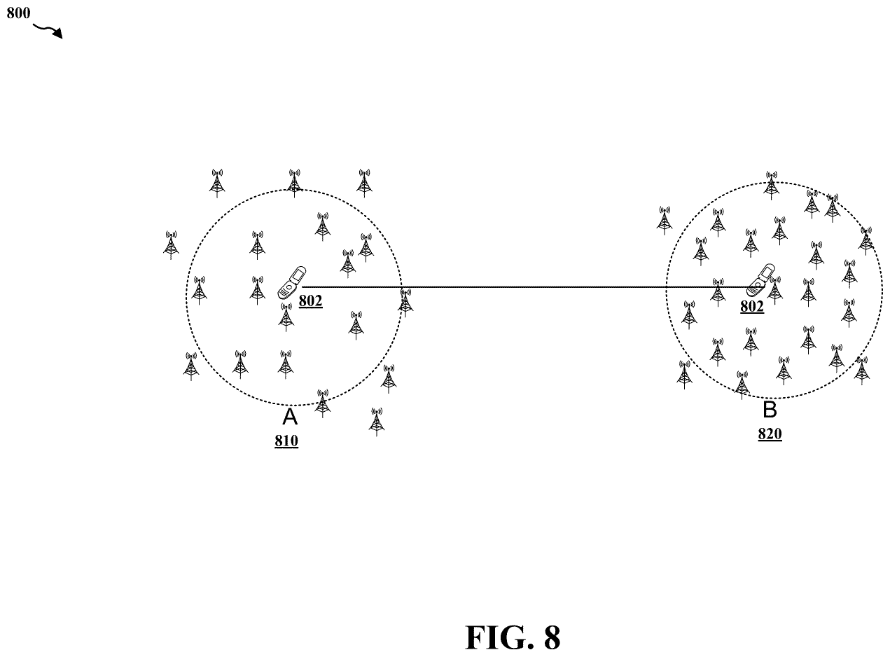

In some aspects, the UE may maintain network node positioning information entries based on a first-in-first-out (FIFO) basis. For example, the UE may maintain a circular buffer where the UE may add network node positioning information entries (which may also be referred to as “BSA entries”) in FIFO manner and maintain a staleness counter for each BSA entry. On arrival of a new network node positioning information entry, the UE may: (1) remove the stale entries based on staleness counter, (2) list out common entries between buffer and new network node positioning information entry, (3) replace all common entries from the buffer, (4) add all the new network node positioning information entries to the buffer and overwrite first-in entries in case buffer is full, and (5) set staleness counter for the new entries to zero. The UE may also update the staleness counter based on time elapsed since storage of the entry or based on a performance of fixing positioning. When a UE moves between two points, the UE may request the corresponding network node positioning information entries associated with serving cell(s) of the two points repeatedly. FIG. 8 is a diagram 800 illustrating an example of a movement of a UE and update of network node positioning information. As the UE 802 moves from location A 810 to location B 820, the UE may request network node positioning information entries around location A 810 and location B 820 repeatedly.

To avoid repeatedly requesting the same network node positioning information entries, in some aspects, the UE may maintain an additional counter for a recency check. Every time the UE performs a position fix (e.g., uses a network node positioning information entry), the UE may increase the recency counter of all the entries corresponding to cells that are getting used as anchor cells, and keep the other recency counters unchanged. Upon arrival of a new network node positioning information entry the UE may: (1) list out common entries between buffer and the new network node positioning information entry, (2) replace all those entries from the buffer, (3) add all the new network node positioning information entries to the buffer, (4) if buffer is full, remove the entries from the buffer that have zero recency counter, (5) use FIFO for tiebreakers, (6) set staleness counter for the new entries to be zero. In such aspects, the UE may remove entries that are not getting used. However, UE may keep some cell for a longer duration, such as in scenarios where the UE moved to a new location and never returns to an older location. For example, if UE 802 is at location A 810 for a long time and the counter values of some cells goes to a high value (e.g., 1000) and zero for rest of the cells. After UE moved to location B 820, the UE may request BSA for new cells and may will keep those high counter value entries at location A for a long time, even if they are not applicable to location B 820. In some aspects, the UE may additionally consider distance between a cell associated with the corresponding entry and a location of the UE or a current serving cell in management of network node positioning information entries. For example, the UE may maintain a staleness counter on each of the network node positioning information entries (e.g., keep on decreasing based on time elapsed or position fix) and maintain a counter for recency check. Every time the UE performs a position fix, the UE may increase the recency counter of all the cell which are getting used (e.g., keep the counter zero or otherwise unchanged for cells that are not in use). On arrival of a new network node positioning information entry the UE may: (1) list out common entries b/w buffer and new BSA, (2) replace all those entries from the buffer, (3) add all the new network node positioning information entries to the buffer, (4) if the buffer is full, remove the entries from the buffer which have zero recency counter, (5) use FIFO for tiebreakers, (6) set staleness counter for the new entries to be zero. Upon updating network node positioning information, the UE may also check the distance of all the cells corresponding to an entry from UE or check the distance of all the cells corresponding to an entry from a serving cell of the UE, and reset recency counter (e.g., to zero) for the cells which are outside a threshold radius with regard to the UE or a current serving cell of the UE.

In some aspects, the UE may also use counter-based decreasing. In some aspects, the UE may maintain a staleness counter on each of the network node positioning information entries and a counter for recency check. Every time the UE makes a fix, the UE may decrease the recency counter of all the cell that are not getting used in the current fix.

In some aspects, to remove the entries with minimum counter value, for tie-breaker, the UE may maintain the history of [MCC, MNC] pair (e.g., or AIT, TAC, or the like) and remove oldest un-used public land mobile network (PLMN) ID, maintain history of frequencies and select set of frequencies to eliminate in FIFO manner.

In some aspects, the UE may request network node positioning information based on serving cell's MCC, MNC, or cell identity. In some aspects, there may be no request for new data unless serving cell changes. In some aspects, the UE may maintain the list of cells for which the network node positioning information is requested. The UE may find the distance between new serving cell and list all serving cells for which the network node positioning information is requested. If the minimum distance is less than a configured threshold, the UE may not request the network node positioning information on the new serving cell. If the minimum distance is less than the configured threshold, the UE may request the network node positioning information on the new serving cell and store the new serving cell in the list. In some aspects, serving cell may be found in the network node positioning information, but some of neighbor cells may be not present in the network node positioning information and there may be minimum (e.g., or maximum) quantities of neighbor cell for scenarios of different TAs, such as a minimum of one cell for a TA between zero and 100 ms, a minimum of two cells for a TA between 100 ms and 500 ms, a minimum of four cells for a TA between 500 ms and 1000 ms, and a minimum of eight cells for a TA greater than 1000 ms.

In some aspects, a UE may find cell entries in network node positioning information based on a combination of MCC, MNC, and cell identity, or a different combination of information that may be present in an entry. In some aspects, finding serving cell entries in network node positioning information may be based on MCC, MNC, and cell identity. In some aspects, a UE's measurement report may include all the identifier for serving cell. In some aspects, for neighbor cells, the UE may use channel number and PCI in a neighbor measurement report (NMR) and may list all the entries in network node positioning information using channel number and PCI. MCC, MNC, and AIT filter based on the serving cell may also be used. The UE may select the nearest one to the serving cell. In some aspects, distance calculation priority rules may be used by the UE to calculate the order with which closeness of the neighbors to serving cell is measured, such as based on antenna locations, centroid locations, or a combination of antenna and centroid locations.

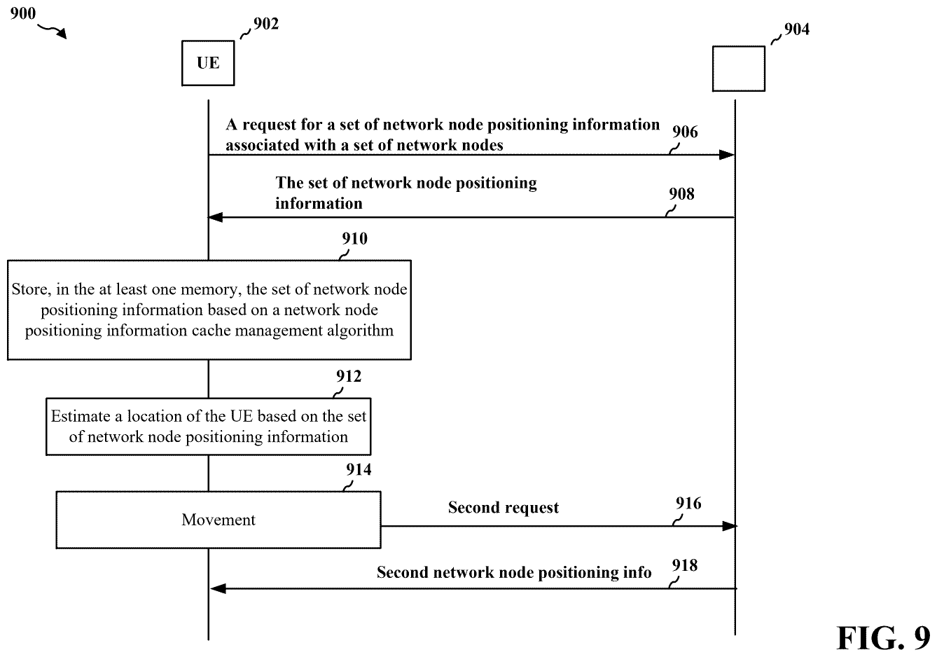

FIG. 9 is a diagram 900 illustrating example communications between a location server 904 and a UE 902. The UE may transmit a request 906 for a set of network node positioning information associated with a set of network nodes to the location server 904 upon a change in serving cell. The location server 904 may provide the set of network node positioning information 908 to the UE 902, and the UE 902 may store, at 910, in at least one memory, the set of network node positioning information based on a network node positioning information cache management algorithm (e.g., as described herein based on FIFO, distance, and various counters). At 912, the UE may estimate a location of the UE based on the set of network node positioning information. Upon movement of the UE at 914 which may involve a serving cell change, the UE may transmit a second request 916 to the location server 904 and receive additional network node positioning information 918, and store the additional network node positioning information 918 based on the network node positioning information cache management algorithm (e.g., as described herein based on FIFO, distance, and various counters).

As an example, a UE may initially maintain a list based on the table below:

TABLE 2
BSA entries

| | Recency | Staleness | | | |
|---|---|---|---|---|---|
| PCI | Counter | Counter | MCC | MNC | EARFCN |
| 32 | 0 | 0 | x | x | x |
| 43 | 0 | 0 | x | x | x |
| 342 | 0 | 0 | x | x | x |
| 12 | 0 | 0 | x | x | x |
| 65 | 0 | 0 | x | x | x |

Upon movement to a new location (e.g., location A 810) for a period of time, the unused entries may be associated with a negative counter, the updated list may be provided below:

TABLE 3
BSA entries after moving to a first new location

| | Recency | Staleness | | | |
|---|---|---|---|---|---|
| PCI | Counter | Counter | MCC | MNC | EARFCN |
| 32 | −5436 | −5436 | x | x | x |
| 43 | 0 | −5436 | x | x | x |
| 342 | 0 | −5436 | x | x | x |
| 12 | −5436 | −5436 | x | x | x |
| 65 | 0 | −5436 | x | x | x |

Upon movement to a second new location (e.g., location B 820) for a period of time, the UE may request new network node positioning information and recency counter of these new entries to zero, the updated list may be provided below:

TABLE 3
BSA entries after moving to a second new location

| | Recency | Staleness | | | |
|---|---|---|---|---|---|
| PCI | Counter | Counter | MCC | MNC | EARFCN |
| 32 | −5436 | −5436 | x | x | x |
| 43 | 0 | −5436 | x | x | x |
| 342 | 0 | −5436 | x | x | x |
| 12 | −5436 | −5436 | x | x | x |
| 65 | 0 | −5436 | x | x | x |
| 43 | 0 | 0 | x | x | x |
| 65 | 0 | 0 | x | x | x |
| 87 | 0 | 0 | x | x | x |

After a period of time at the second new location, counters of last used cells at the first new location may start moving on negative side, the updated list may be provided below:

TABLE 4
BSA entries after moving to a second
new location for a period of time

| | Recency | Staleness | | | |
|---|---|---|---|---|---|
| PCI | Counter | Counter | MCC | MNC | EARFCN |
| 32 | −5779 | −5779 | x | x | x |
| 43 | −343 | −5779 | x | x | x |
| 342 | −343 | −5779 | x | x | x |
| 12 | −5779 | −5779 | x | x | x |
| 65 | −343 | −5779 | x | x | x |
| 43 | 0 | −343 | x | x | x |
| 65 | 0 | −343 | x | x | x |
| 87 | −343 | −343 | x | x | x |

If storage space runs out, the UE may remove the most negative counter valued entries as provided in the table below:

TABLE 5
Removal of some BSA entries after moving to
a second new location for a period of time

| | Recency | Staleness | | | |
|---|---|---|---|---|---|
| PCI | Counter | Counter | MCC | MNC | EARFCN |
| 43 | −343 | −5779 | x | x | x |
| 342 | −343 | −5779 | x | x | x |
| 65 | −343 | −5779 | x | x | x |
| 43 | 0 | −343 | x | x | x |
| 65 | 0 | −343 | x | x | x |
| 87 | −343 | −343 | x | x | x |

If the UE moves back to the first new location (e.g., location A 810), the UE may start using entries with the less negative values that may be present in the buffer, the updated list may be provided below:

TABLE 6
BSA entries after moving back to the first
new location for a period of time

| | Recency | Staleness | | | |
|---|---|---|---|---|---|
| PCI | Counter | Counter | MCC | MNC | EARFCN |
| 43 | 0 | −5780 | x | x | x |
| 342 | 0 | −5780 | x | x | x |
| 65 | 0 | −5780 | x | x | x |
| 43 | −1 | −344 | x | x | x |
| 65 | −1 | −344 | x | x | x |
| 87 | −344 | −344 | x | x | x |

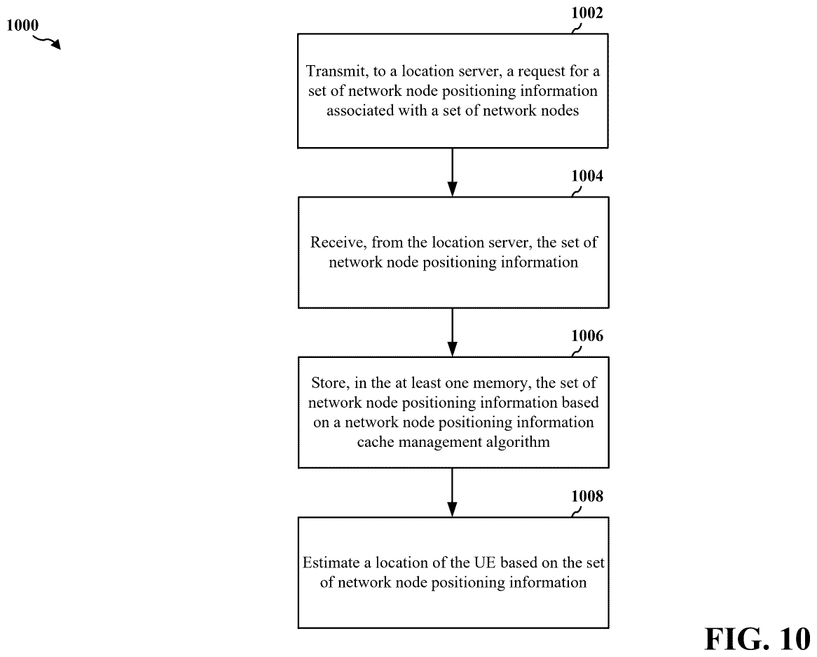

FIG. 10 is a flowchart 1000 of a method of wireless communication. The method may be performed by a UE (e.g., the UE 104, the UE 902; the apparatus 1104).

At 1002, the UE may transmit, to a location server, a request for a set of network node positioning information associated with a set of network nodes. For example, the UE 902 may transmit, to a location server 904, a request (e.g., 906) for a set of network node positioning information associated with a set of network nodes. In some aspects, 1002 may be performed by positioning component 198.

At 1004, the UE may receive, from the location server, the set of network node positioning information. For example, the UE 902 may receive, from the location server 904, the set of network node positioning information (e.g., 908). In some aspects, 1004 may be performed by positioning component 198.

At 1006, the UE may store, in the at least one memory (e.g., at the UE), the set of network node positioning information based on a network node positioning information cache management algorithm. For example, the UE 902 may store (e.g., 910), in the at least one memory, the set of network node positioning information based on a network node positioning information cache management algorithm. In some aspects, 1006 may be performed by positioning component 198.

At 1008, the UE may estimate a location of the UE based on the set of network node positioning information. For example, the UE 902 may estimate (e.g., 912) a location of the UE based on the set of network node positioning information. In some aspects, 1006 may be performed by positioning component 198.

In some aspects, the network node positioning information cache management algorithm is based on first-in-first-out (FIFO), and where the UE may transmit, to the location server, a second request (e.g., 916) for a second set of network node positioning information associated with a second set of network nodes upon movement of the UE, receive (e.g., 918), from the location server, the second set of network node positioning information, and replace, in the at least one memory, a portion of the set of network node positioning information with the second set of network node positioning information based on at least one storage time (e.g., replacing the entries in the first set of network node positioning information with the earliest storage time or storage time earlier than a threshold).

In some aspects, the at least one memory includes a set of partitioned portions, where each partitioned portion of the set of partitioned portions is associated with a respective serving cell identifier (ID), and where the UE may transmit, to the location server, a second request (e.g., 916) for a second set of network node positioning information associated with a second set of network nodes upon movement of the UE and replace, in the at least one memory, a portion of the set of network node positioning information with the second set of network node positioning information based on at least one distance from a current serving cell or the UE associated with the portion being above a threshold (e.g., replacing the entries with that is further away from the current serving cell or the UE itself).

In some aspects, each entry of the set of network node positioning information in the at least one memory is associated with a respective usage counter (e.g., the recency counter or a different type of counter that may be based on usage of an entry), where the UE may increase the respective usage counter upon a use of a corresponding entry, transmit, to the location server, a second request (e.g., 916) for a second set of network node positioning information (e.g., 918) associated with a second set of network nodes upon movement of the UE, and replace, in the at least one memory, at least one entry of the set of network node positioning information with the second set of network node positioning information based on at least one counter associated with the at least one entry (e.g., replacing the entries with the lowest usage counter or usage counter below a threshold). In some aspects, the at least one counter associated with the at least one entry that is configured to be replaced is zero.

In some aspects, each entry of the set of network node positioning information in the at least one memory is associated with a respective usage counter, where the UE may increase the respective usage counter upon a use of a corresponding entry, transmit, to the location server, a second request (e.g., 916) for a second set of network node positioning information (e.g., 918) associated with a second set of network nodes upon movement of the UE, reset each usage counter associated with an entry associated with a network node that has a distance from a current serving cell or the UE above a threshold (e.g., too far away from the serving cell or the UE itself), and replace, in the at least one memory, at least one entry of the set of network node positioning information with the second set of network node positioning information based on at least one counter associated with the at least one entry. In some aspects, the at least one counter associated with the at least one entry that is configured to be replaced is zero.

In some aspects, each entry of the set of network node positioning information in the at least one memory is associated with a respective usage counter, where the UE may decrease the respective usage counter upon a use of a different entry (e.g., decrease the usage counter of unused entries), transmit, to the location server, a second request (e.g., 916) for a second set of network node positioning information (e.g., 918) associated with a second set of network nodes upon movement of the UE, replace, in the at least one memory, at least one entry of the set of network node positioning information with the second set of network node positioning information based on at least one counter associated with the at least one entry.

In some aspects, the request for the set of network node positioning information associated with the set of network nodes is based on at least one mobile country code (MCC), at least one mobile network code (MNC), at least one tracking code, and at least one cell identity (CI). In some aspects, the UE may determine the set of network nodes to be associated with the request based on a threshold distance of a current serving cell of the UE or the UE. In some aspects, a quantity of the set of network nodes is based on a timing advance (TA) associated with a current serving cell of the UE. In some aspects, the UE may transmit a measurement report based on the location.

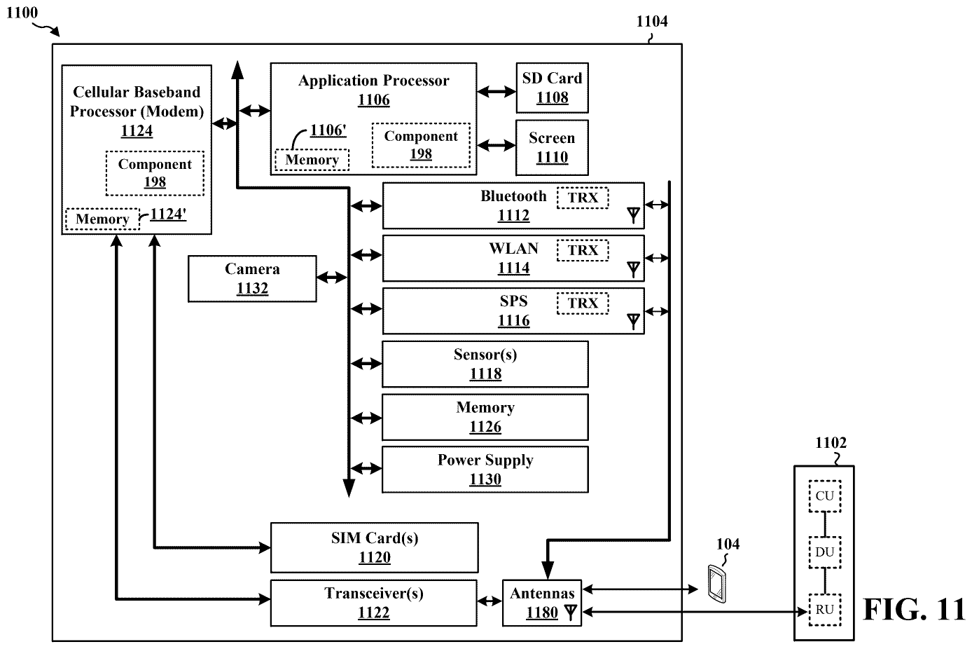

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); ranging, sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359.

In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the positioning component 198 may be configured to transmit, to a location server, a request for a set of network node positioning information associated with a set of network nodes. In some aspects, the positioning component 198 may be further configured to receive, from the location server, the set of network node positioning information. In some aspects, the positioning component 198 may be further configured to store, in the at least one memory, the set of network node positioning information based on a network node positioning information cache management algorithm. In some aspects, the positioning component 198 may be further configured to estimate a location of the UE based on the set of network node positioning information. The positioning component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for transmitting, to a location server, a request for a set of network node positioning information associated with a set of network nodes. In some aspects, the apparatus 1104 may include means for receiving, from the location server, the set of network node positioning information. In some aspects, the apparatus 1104 may include means for storing, in at least one memory at the UE, the set of network node positioning information based on a network node positioning information cache management algorithm. In some aspects, the apparatus 1104 may include means for estimating a location of the UE based on the set of network node positioning information. In some aspects, the apparatus 1104 may include means for transmitting, to the location server, a second request for a second set of network node positioning information associated with a second set of network nodes upon movement of the UE. In some aspects, the apparatus 1104 may include means for receiving, from the location server, the second set of network node positioning information. In some aspects, the apparatus 1104 may include means for replacing, in the at least one memory, a portion of the set of network node positioning information with the second set of network node positioning information based on at least one storage time. In some aspects, the apparatus 1104 may include means for transmitting, to the location server, a second request for a second set of network node positioning information associated with a second set of network nodes upon movement of the UE. In some aspects, the apparatus 1104 may include means for replacing, in the at least one memory, a portion of the set of network node positioning information with the second set of network node positioning information based on at least one distance from a current serving cell or the UE associated with the portion being above a threshold. In some aspects, the apparatus 1104 may include means for increasing the respective usage counter upon a use of a corresponding entry. In some aspects, the apparatus 1104 may include means for transmitting, to the location server, a second request for a second set of network node positioning information associated with a second set of network nodes upon movement of the UE. In some aspects, the apparatus 1104 may include means for replacing, in the at least one memory, at least one entry of the set of network node positioning information with the second set of network node positioning information based on at least one counter associated with the at least one entry. In some aspects, the apparatus 1104 may include means for increasing the respective usage counter upon a use of a corresponding entry. In some aspects, the apparatus 1104 may include means for transmitting, to the location server, a second request for a second set of network node positioning information associated with a second set of network nodes upon movement of the UE. In some aspects, the apparatus 1104 may include means for resetting each usage counter associated with an entry associated with a network node that has a distance from a current serving cell or the UE above a threshold. In some aspects, the apparatus 1104 may include means for replacing, in the at least one memory, at least one entry of the set of network node positioning information with the second set of network node positioning information based on at least one counter associated with the at least one entry. In some aspects, the apparatus 1104 may include means for decreasing the respective usage counter upon a use of a different entry. In some aspects, the apparatus 1104 may include means for transmitting, to the location server, a second request for a second set of network node positioning information associated with a second set of network nodes upon movement of the UE. In some aspects, the apparatus 1104 may include means for replacing, in the at least one memory, at least one entry of the set of network node positioning information with the second set of network node positioning information based on at least one counter associated with the at least one entry. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is an apparatus for wireless communication at a user equipment (UE), including: at least one memory; and at least one processor coupled to the at least one memory, based at least in part on information stored in the at least one memory, the at least one processor is configured to: transmit, to a location server, a request for a set of network node positioning information associated with a set of network nodes; receive, from the location server, the set of network node positioning information; and store, in the at least one memory, the set of network node positioning information based on a network node positioning information cache management algorithm.
Aspect 2 is the apparatus of aspect 1, where the network node positioning information cache management algorithm is based on first-in-first-out (FIFO), and where the at least one processor is configured to: transmit, to the location server, a second request for a second set of network node positioning information associated with a second set of network nodes upon movement of the UE; receive, from the location server, the second set of network node positioning information; and replace, in the at least one memory, a portion of the set of network node positioning information with the second set of network node positioning information based on at least one storage time.
Aspect 3 is the apparatus of any of aspects 1-2, where the at least one memory includes a set of partitioned portions, where each partitioned portion of the set of partitioned portions is associated with a respective serving cell identifier (ID), and where the at least one processor is configured to: transmit, to the location server, a second request for a second set of network node positioning information associated with a second set of network nodes upon movement of the UE; and replace, in the at least one memory, a portion of the set of network node positioning information with the second set of network node positioning information based on at least one distance from a current serving cell or the UE associated with the portion being above a threshold.
Aspect 4 is the apparatus of any of aspects 1-3, where each entry of the set of network node positioning information in the at least one memory is associated with a respective usage counter, where the at least one processor is further configured to: increase the respective usage counter upon a use of a corresponding entry; transmit, to the location server, a second request for a second set of network node positioning information associated with a second set of network nodes upon movement of the UE; and replace, in the at least one memory, at least one entry of the set of network node positioning information with the second set of network node positioning information based on at least one counter associated with the at least one entry.
Aspect 5 is the apparatus of aspect 4, where the at least one counter associated with the at least one entry that is configured to be replaced is zero.
Aspect 6 is the apparatus of any of aspects 1-5, where each entry of the set of network node positioning information in the at least one memory is associated with a respective usage counter, where the at least one processor is further configured to: increase the respective usage counter upon a use of a corresponding entry; transmit, to the location server, a second request for a second set of network node positioning information associated with a second set of network nodes upon movement of the UE; reset each usage counter associated with an entry associated with a network node that has a distance from a current serving cell or the UE above a threshold; and replace, in the at least one memory, at least one entry of the set of network node positioning information with the second set of network node positioning information based on at least one counter associated with the at least one entry.
Aspect 7 is the apparatus of any of aspects 4-6, where the at least one counter associated with the at least one entry that is configured to be replaced is zero.
Aspect 8 is the apparatus of any of aspects 1-7, where each entry of the set of network node positioning information in the at least one memory is associated with a respective usage counter, where the at least one processor is further configured to: decrease the respective usage counter upon a use of a different entry; transmit, to the location server, a second request for a second set of network node positioning information associated with a second set of network nodes upon movement of the UE; and replace, in the at least one memory, at least one entry of the set of network node positioning information with the second set of network node positioning information based on at least one counter associated with the at least one entry.
Aspect 9 is the apparatus of any of aspects 1-8, where the request for the set of network node positioning information associated with the set of network nodes is based on at least one mobile country code (MCC), at least one mobile network code (MNC), at least one tracking area code, and at least one cell identity (CI).
Aspect 10 is the apparatus of any of aspects 1-9, where the at least one processor is configured to: determine the set of network nodes to be associated with the request based on a threshold distance of a current serving cell of the UE or the UE.
Aspect 11 is the apparatus of any of aspects 1-10, where a quantity of the set of network nodes is based on a timing advance (TA) associated with a current serving cell of the UE.
Aspect 12 is the apparatus of any of aspects 1-11, where the at least one processor is configured to: estimate a location of the UE based on the set of network node positioning information.
Aspect 13 is the apparatus of aspect 12, where the at least one processor is configured to: transmit a measurement report based on the location of the UE.
Aspect 14 is a method of wireless communication for implementing any of aspects 1 to 13.
Aspect 15 is a computer-readable medium (e.g., a non-transitory computer-readable medium) storing computer executable code, the code when executed by at least one processor causes the at least one processor to implement any of aspects 1 to 13.
Aspect 16 is an apparatus comprising means for implementing any of aspects 1 to 13.

What is claimed is:

1. An apparatus for wireless communication at a user equipment (UE), comprising:
at least one memory; and
at least one processor coupled to the at least one memory, based at least in part on information stored in the at least one memory, the at least one processor is configured to:
transmit, to a location server, a request for a set of network node positioning information associated with a set of network nodes;
receive, from the location server, the set of network node positioning information; and
store, in the at least one memory, the set of network node positioning information based on a network node positioning information cache management algorithm.

2. The apparatus of claim 1, wherein the network node positioning information cache management algorithm is based on first-in-first-out (FIFO), and wherein the at least one processor is further configured to:
transmit, to the location server, a second request for a second set of network node positioning information associated with a second set of network nodes upon movement of the UE;
receive, from the location server, the second set of network node positioning information; and
replace, in the at least one memory, a portion of the set of network node positioning information with the second set of network node positioning information based on at least one storage time.

3. The apparatus of claim 1, wherein the at least one memory comprises a set of partitioned portions, wherein each partitioned portion of the set of partitioned portions is associated with a respective serving cell identifier (ID), and wherein the at least one processor is further configured to:
transmit, to the location server, a second request for a second set of network node positioning information associated with a second set of network nodes upon movement of the UE; and
replace, in the at least one memory, a portion of the set of network node positioning information with the second set of network node positioning information based on at least one distance from a current serving cell or the UE associated with the portion being above a threshold.

4. The apparatus of claim 1, wherein each entry of the set of network node positioning information in the at least one memory is associated with a respective usage counter, wherein the at least one processor is further configured to:
increase the respective usage counter upon a use of a corresponding entry;
transmit, to the location server, a second request for a second set of network node positioning information associated with a second set of network nodes upon movement of the UE; and
replace, in the at least one memory, at least one entry of the set of network node positioning information with the second set of network node positioning information based on at least one counter associated with the at least one entry.

5. The apparatus of claim 4, wherein the at least one counter associated with the at least one entry that is configured to be replaced is zero.

6. The apparatus of claim 1, wherein each entry of the set of network node positioning information in the at least one memory is associated with a respective usage counter, wherein the at least one processor is further configured to:
increase the respective usage counter upon a use of a corresponding entry;
transmit, to the location server, a second request for a second set of network node positioning information associated with a second set of network nodes upon movement of the UE;
reset each usage counter associated with an entry associated with a network node that has a distance from a current serving cell or the UE above a threshold; and
replace, in the at least one memory, at least one entry of the set of network node positioning information with the second set of network node positioning information based on at least one counter associated with the at least one entry.

7. The apparatus of claim 4, wherein the at least one counter associated with the at least one entry that is configured to be replaced is zero.

8. The apparatus of claim 1, wherein each entry of the set of network node positioning information in the at least one memory is associated with a respective usage counter, wherein the at least one processor is further configured to:
decrease the respective usage counter upon a use of a different entry;
transmit, to the location server, a second request for a second set of network node positioning information associated with a second set of network nodes upon movement of the UE; and
replace, in the at least one memory, at least one entry of the set of network node positioning information with the second set of network node positioning information based on at least one counter associated with the at least one entry.

9. The apparatus of claim 1, wherein the request for the set of network node positioning information associated with the set of network nodes is based on at least one mobile country code (MCC), at least one mobile network code (MNC), at least one tracking area code, and at least one cell identity (CI).

10. The apparatus of claim 1, wherein the at least one processor is further configured to:
determine the set of network nodes to be associated with the request based on a threshold distance of a current serving cell of the UE or the UE.

11. The apparatus of claim 1, wherein a quantity of the set of network nodes is based on a timing advance (TA) associated with a current serving cell of the UE.

12. The apparatus of claim 1, wherein the at least one processor is further configured to:
estimate a location of the UE based on the set of network node positioning information.

13. The apparatus of claim 12, wherein the at least one processor is further configured to:
transmit a measurement report based on the location of the UE.

14. A method for wireless communication performed by a user equipment (UE), comprising:
transmitting, to a location server, a request for a set of network node positioning information associated with a set of network nodes;
receiving, from the location server, the set of network node positioning information; and
storing, in at least one memory at the UE, the set of network node positioning information based on a network node positioning information cache management algorithm.

15. The method of claim 14, wherein the network node positioning information cache management algorithm is based on first-in-first-out (FIFO), and further comprising:
transmitting, to the location server, a second request for a second set of network node positioning information associated with a second set of network nodes upon movement of the UE;
receiving, from the location server, the second set of network node positioning information; and
replacing, in the at least one memory, a portion of the set of network node positioning information with the second set of network node positioning information based on at least one storage time.

16. The method of claim 14, wherein the at least one memory comprises a set of partitioned portions, wherein each partitioned portion of the set of partitioned portions is associated with a respective serving cell identifier (ID), and further comprising:
transmitting, to the location server, a second request for a second set of network node positioning information associated with a second set of network nodes upon movement of the UE; and
replacing, in the at least one memory, a portion of the set of network node positioning information with the second set of network node positioning information based on at least one distance from a current serving cell associated with the portion being above a threshold.

17. The method of claim 14, wherein each entry of the set of network node positioning information in the at least one memory is associated with a respective usage counter, and further comprising:
increasing the respective usage counter upon a use of a corresponding entry;
transmitting, to the location server, a second request for a second set of network node positioning information associated with a second set of network nodes upon movement of the UE; and
replacing, in the at least one memory, at least one entry of the set of network node positioning information with the second set of network node positioning information based on at least one counter associated with the at least one entry.

18. The method of claim 14, wherein each entry of the set of network node positioning information in the at least one memory is associated with a respective usage counter, and further comprising:
increasing the respective usage counter upon a use of a corresponding entry;
transmitting, to the location server, a second request for a second set of network node positioning information associated with a second set of network nodes upon movement of the UE;
resetting each usage counter associated with an entry associated with a network node that has a distance from a current serving cell above a threshold; and
replacing, in the at least one memory, at least one entry of the set of network node positioning information with the second set of network node positioning information based on at least one counter associated with the at least one entry.

19. The method of claim 14, wherein each entry of the set of network node positioning information in the at least one memory is associated with a respective usage counter, and further comprising:
decreasing the respective usage counter upon a use of a different entry;
transmitting, to the location server, a second request for a second set of network node positioning information associated with a second set of network nodes upon movement of the UE; and
replacing, in the at least one memory, at least one entry of the set of network node positioning information with the second set of network node positioning information based on at least one counter associated with the at least one entry.

20. A computer-readable medium storing computer executable code at a user equipment (UE), the code when executed by at least one processor causes the at least one processor to:
transmit, to a location server, a request for a set of network node positioning information associated with a set of network nodes;
receive, from the location server, the set of network node positioning information; and
store, in at least one memory at the UE, the set of network node positioning information based on a network node positioning information cache management algorithm.
